(19) United States
(12) Patent Application Publication
(10) Pub. No.: US 2004/0081728 A1
(43) Pub. Date: Apr. 29, 2004

(54) Container for a pressurized beverage

(76) Inventors: Thomas Haermeyer, Offenbach (DE); Richard Reichinger, Liverpool (GB); Bertold Bast, Bonn (DE)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/622,399

(22) Filed: Jul. 18, 2003

Related U.S. Application Data
(63) Continuation of application No. 09/254,618, filed on Oct. 20, 1999, now abandoned.
Application No. 09/254,618 is a 371 of international application No. PCT/DE97/02022, filed on Sep. 10, 1997.

(30) Foreign Application Priority Data
Nov. 9, 1996 (DE) 196 38 182.7

(51) Int. Cl. A23B 4/00

(52) U.S. Cl. 426/124

(57) ABSTRACT

This invention concerns a beverage container for containing a beverage under gas pressure. The beverage container has a floor and a gas container attached inside the beverage container to the beverage container floor. The gas container has a floor made out of an elastic material and has an upper part. The gas container floor is connected via a snap connection with the beverage container floor.

The present invention relates to beverage containers for pressurized beverages.

Said beverages can be non-carbonated beverages, beverages with a low carbonic acid content or carbonated beverages. Beer, for example, should form nice, stable froth when opened and filled into a glass. However, said beverages also include other drinks, e.g. non-alcoholic carbonated beverages with or without froth such as so-called soft drinks like Cola, carbonated lemonades, etc., but also non-carbonated beverages to be stored in the container under a gas other than air to prevent, for example, the content from oxidizing (e.g. apple or orange juice, milk shakes, tea, coffee). Here, it is frequently desirable, though not necessarily obligatory (e.g. in the case of apple juice), that the pressure in the filled beverage container is higher than ambient pressure.

There are numerous suggestions aimed to provide beverage containers of the above type with an internal container which, during the filling process, can be filled with gaseous or liquid nitrogen or another gas in which case it may well be that the internal container fills up in part or completely with liquid, which can be displaced again by part of the existing gas or liquid gas volume once the container is closed. In the following, such container will be referred to as “gas container”, even though it may contain a liquid as well as a gas. Gas containers of this type are known for example from the international patent applications published under numbers WO 95/08493, WO 91/07326, WO 95/00416 and WO 95/00415.

There have been suggestions for both a gas container which floats on or drifts in the liquid and a gas container firmly fixed to the container. Thus, WO 91/07326 suggests among other things that the gas container be provided with flexible arms with flanges, which press-fit the gas container to the container at a predefined location in an upper or middle area of the container.

This has the disadvantage that the proposed press fit does not provide a secure adhesion, as metal or plastic containers may have slightly varying inside diameters depending on the state of the production tool and because their side walls may be “distended” to a larger or lesser extent depending on internal pressure. For this reason, the said publication suggests in addition that, after insertion of the gas container, the side wall of the container be curved inwardly above the fixing point to firmly fix the gas container.

However, this requires an additional container reshaping step, which can take place only after insertion of the gas container and is thus very complicated to carry out.

WO 95/08493 suggests affixing the internal gas container to the container bottom by means of an adhesive. In this case, the gas container should preferably be open to the bottom end and be provided with a flange, whose shape essentially follows that of a portion of the bottom wall and is affixed to this by means of the adhesive. However, in such cases a heavy-duty adhesive is required, which can withstand high pressure. In an alternative embodiment the gas container is a closed container with a plane bottom whose centre portion is affixed to the inside of the dome of the bottom part by means of an adhesive. It is true that the adhesive can be less expensive as it need not resist such high pressures. Nevertheless, the adhesive in the outer area of the adhesive joint tends to run inhomogeneously as the gap between and the gas container becomes larger towards the outside. Moreover, the adhesive will come in contact with the beverage, so-that only adhesive may be used which is allowed according to the law relating to foods and drugs.

It is an objects of the present invention to circumvent the above described disadvantages and provide a beverage container with a gas container wherein manufacture of the gas container is very simple and inexpensive, whilst it is relatively easy to affix the gas container to the beverage container and fill the container with gas and beverage.

This problem is solved by providing a container in accordance with claim 1, which can receive or contain a pressurized beverage and is provided with a gas container attached to the inside of the container bottom, which gas container consists of a bottom part made of an elastic material and an upper part, wherein the bottom part is connected to the container bottom by means of a snap connection.

The container itself my consist of usual beverage container material. It might for example be a beverage can or a keg made from aluminium or sheet steel, or it might be a beverage container made of a plastic material such as polyethylene terephthalate, polyethylene, polypropylene or another food-grade plastic. Glass containers are also covered by the present invention. The containers can be manufactured in the usual way. Thus, 2-piece or 3-piece beverage cans may be used.

The word “gas container” was chosen to express that the internal container designated by this term should at least in part contain gas when it is in the filled beverage container. In most cases, it also contains a certain amount of liquid. Usually, in the case of beverage containers which are of interest to the present invention, filling takes place in the following way: the internal container is filled with gas, the container is subsequently filled with beverage and finally closed. Depending on the design of the internal container, liquid may flow into the gas container due to pressure compensation during or after seaming; this is explained in detail below.

The gas container of the present invention is located on the container bottom. Thus, in a filled state of the container, it is surrounded by liquid. The inside of the gas container is connected to this liquid in such a way that the gas contained in the gas container cannot escape into the surrounding liquid in a filled and closed can. In this context, the state of the art has various suggestions. One option is to provide the gas container with reversibly closed openings, in which case the closure or closures is/are destroyed as a result of the sudden decrease in the pressure of the liquid which takes place when the can is opened, and the gas can escape into the surrounding liquid. Alternatively, the gas container is for example provided with at least one and in particular two openings of only small diameter whose dimensions are such that the surface tension of the liquid prevents gas bubbles from escaping as long as the filled container is closed. This effect is known as the so-called “gas bubble point effect”.

If, apart from said openings, the gas container is a closed hollow body, it will be referred to as “forming an essentially closed hollow body” in the following.

At least the bottom part of the gas container should be made of an elastic material such as plastic or metal. The bottom and upper parts can be designed as one integral part, or they can be made of separate parts which are subsequently connected to one another, e.g. by a weld (e.g. by friction welding), by an adhesive joint or by a snap connection. The upper part can but need not, consist of the same material as the bottom part.

Since the gas container is located on the beverage container bottom, it need not necessarily form an essentially closed hollow body by itself. Instead, the gas container can be open at the bottom, as long as its connection to the container bottom is so tight around the opening that it meets the above “gas bubble point effect” criteria.

The dependent claims set forth further embodiments of the container in accordance with the present invention.

In the following, the invention is explained on the basis of drawings. The individual features explained on the basis of a figure shall not be restricted to the combinations with the other features specifically shown in this figure.

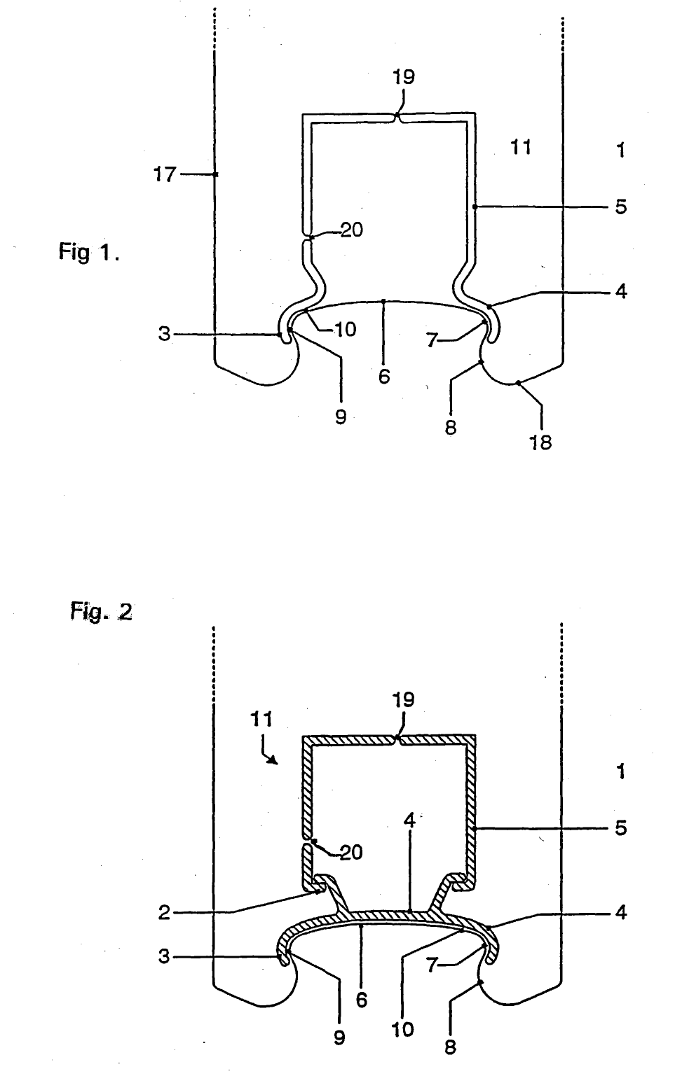

FIG. 1 shows the longer part of a container 1 for a beverage of the above type. There may be seen the lower part of the side wall 17 as well as the container bottom 10, which is noticeabley involuted. The involution has an inner section 6, which in this embodiment is shaped like a dome, but which might also be plane. This blends into a first annular section 7 of relatively large diameter. A second annular section 8 which is located nearer the bottom has a smaller diameter than the first section, so that the container bottom is necked in this area. The bottom then becomes wider again and finally converges into another annular section 18 on which the container stands.

The gas container 11 consists of a bottom part 4 and an upper part 5 which form an integral part in this example. Two openings 19, 20 of very small diameter are provided, one on the top and the other in a lower part of the side wall. The diameters of said openings should be so small that, in a filled and closed can, the surface tension of the liquid surrounding the gas container prevents gas from escaping from the gas container.

In this example, the bottom part 4 of the gas container has a circular opening in its centre so that the dome-shaped section 6 of the container bottom closes the interior of the gas container. The opening is not restricted to the shape as shown. Naturally, the gas container might also encase an essentially closed cavity. The connection between the bottom part 4 of the gas container and the container bottom 10 is achieved in such a way, that the bottom part 4 is provided with an annular section 3 whose contour matches that of a portion of the dome-shaped section 6 and the annular section 7 of container bottom 10 and which completely wraps around section 7. Due to the flexibility of bottom part 4, a tight snap connection is achieved in this way.

FIG. 2 shows an alternative embodiment of the gas container 11 in a container 1 designed like that of FIG. 1. Here, the gas container consists of an upper part 5 and a bottom part 4 which were formed as separate parts and were subsequently joined together. The joint 2 as shown is exemplary of a snap connection of an adhesive joint. Bottom part 4 is closed, so that the gas container as such forms an essentially closed hollow body, apart from the small-diameter openings through which the gas compartment is connected with the liquid compartment.

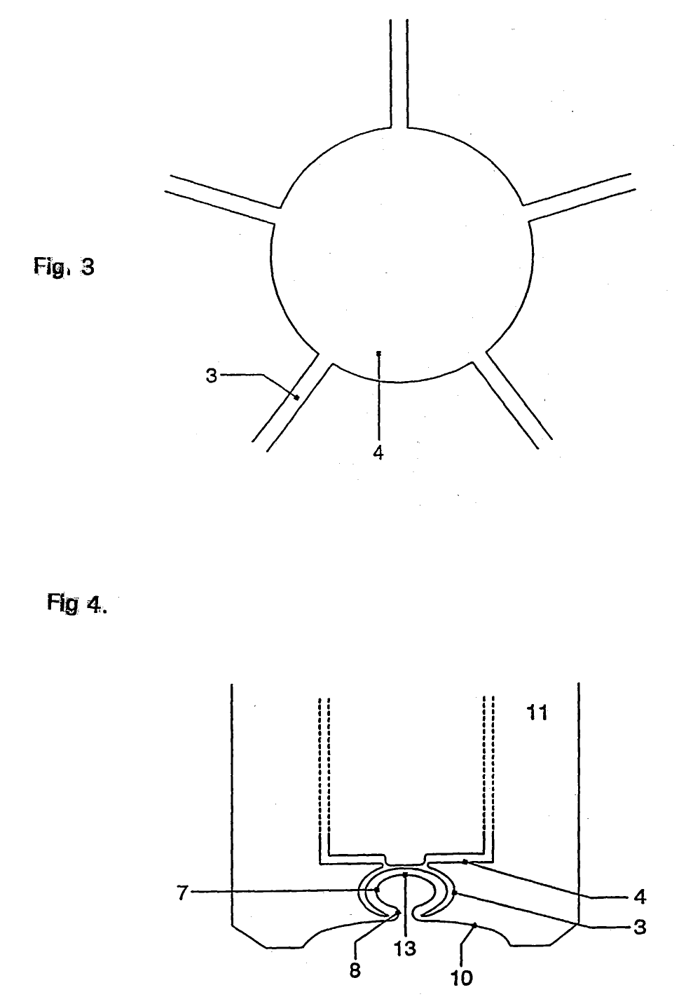

Section 3 of bottom part 4 can be of annular shape, so that the outer portion of bottom part 4 corresponds with the embodiment described in FIG. 1. Section 3 might also take the form of small legs or feet wrapping around section 7 of the container bottom. The number of feet is variable in this embodiment. If the snap connection is very strong, two or three of these wrapping structures my suffice; but there might be as well four of five or even more legs or feet-which in this case will probably be thinner. FIG. 3 is a view from below onto the bottom part 4 in an embodiment with five feet.

It should be clear that also the design of section 3 of bottom part 4 of the gas container (“leg-type” or annular design) may be chosen freely as long as the gas container is sealed satisfactorily.

FIG. 4 shows another embodiment of the invention, wherein the container bottom 10 has a smaller central involution 13. It may be seen that the smaller involution 13 comprises a first annular section 7 of slightly larger diameter and a second annular section 8 of smaller diameter, which is located nearer the bottom. (The scale of this figure is not necessarily correct, rather, the proportions of involution 13 are somewhat exaggerated.) Thus, a neck is formed which gives the involution 13 the shape of a mushroom. Thus, it may be wrapped by section 3 of bottom part 4 of the gas container 11 in a snapping way. Section 3 of bottom part 4 can consist of several legs or feet (for example three relatively wide feet or five or six thinner legs or feet), or it may be an annular structure which completely wraps around section 7 of container bottom 10.

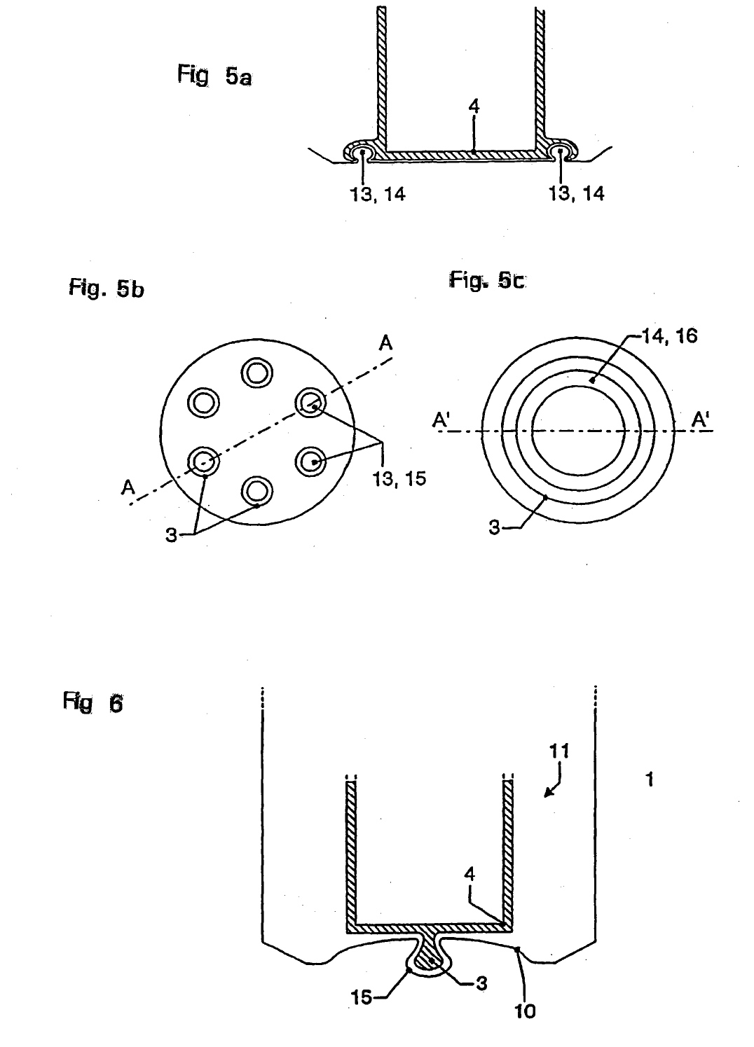

In the two embodiments which are represented schematically in FIGS. 5b and 5c as views from below onto the bottom, a cross-section along lines A-A and A′-A′ respectively gives a design as shown in FIG. 5a. FIG. 5b shows a series of small involutions 13 which are spaced annularly on the container bottom. A section 3 of bottom part 4 snaps around each of these involutions. FIG. 5c shows an annular groove-like involution 14 around which an annular section 3 of bottom part 4 snaps. The embodiment with several small involutions 13 may naturally have a different number and/or a different layout of involutions (e.g. with a central involution).

FIG. 6 shows another embodiment of the invention, wherein the container bottom 10 is provided with a marked dome, which in turn is provided with a central, mushroom-shaped projection 15. A mushroom or button-like section 3 of bottom part 4 of the gas container 11 snaps into this projection.

Instead of the central projection 15 as shown in FIG. 6, the container bottom can be provided with several smaller projections 15, which could, for example, be distributed as shown in FIG. 5b. Alternatively, and analogous with the embodiment as shown in FIG. 5c, there might be a groove-shaped projection 16, into which an annular section 3 of bottom part 4 of the gas container 11 can be snapped, which section 3 has a mushroom-shaped cross-section.

Instead of the snap connection between the bottom part of the gas container and the container bottom, a connection via a corresponding structure located near the bottom end of the container side wall is also possible.

The combinations of the various features of the gas container bottom part and the container bottom shown in the figures are interchangeable wherever this is feasible. Thus, bottom 4 of the gas container as shown in FIG. 5a might naturally be open downwardly, if the snap connection symbolized by 13, 14 is sufficiently tight. Also, all gas containers may consist of one or several parts.

The present invention covers beverage containers both before and after filling with the respective beverage and therefore both in an unclosed or closed state. Moreover, the invention covers the gas containers per se.

Preferably, the beverage container is filled in the following manner: First, the container is flushed with gas or filled with liquid gas. The gas can be chosen freely depending on requirements, however, frequently nitrogen is used. If the gas container as such forms an essentially closed hollow body, the gas, which preferably is partly liquid, may be filled in its or one of its openings either when the gas container is already snap-fitted to the container bottom or before it is snap-fitted to the container bottom. Subsequently, the container is filled with liquid. Preferably, to flush the headspace above the liquid surface, another drop of liquid gas is added before the can is closed. If it is subsequently inverted, in the preferred embodiments, wherein the gas container has two openings of small diameter, part of the gas can escape from the gas container into the beverage container, whilst at the same time liquid flows into the gas container until a balance of pressure is reached. If the can is now opened with the closed end again uppermost, the sudden pressure decrease in the beverage and, as a result, the increasing pressure difference between the interior of the gas container and the beverage make it possible for gas to escape at high speed, which results in the desired gas bubbles and, if applicable, appetizing froth.

1. A container (1) for a gas pressurized beverage with a gas container (11) attached to the inside of the container bottom (10), which gas container comprises a bottom part (4) made of an elastic material and an upper part (5), the bottom part being connected to the container bottom (10) via a snap connection (9).

2. A container according to claim 1 wherein the bottom part (4) of the gas container (11) is provided with an opening.

3. A container according to claim 1 wherein the bottom part (4) and the upper part (5) of the gas container (11) form an essentially closed hollow body.

4. A container according to any of claims 1 through 3 wherein the snap connection (9) is formed in that the container bottom (10) is provided with at least one involution (7) and that at least one section (3) of the bottom part (4) of the gas container (11) is shaped in such a way that it snaps around at least one involution (7) of the container bottom (10).

5. A container according to any of claims 1 through 3 wherein the snap connection (9) is formed in that the container is provided with at least one projection (15) in the bottom area of the container bottom (10) and that at least one section (3) of the bottom part (4) of the gas container (11) is shaped in such a way that it snaps into at least one projection (15) of the container bottom (10).

6. A container according to claim 4 or 5 wherein several sections (3) of the bottom part (4) of the gas container are shaped like small legs or feet which snap around or into the corresponding structure(s) of the container bottom (10).

7. A container according to claim 4 or 5 wherein section (3) of the bottom part (4) of the gas container (11) has an annular contour and snaps around or into corresponding annular structures of the container bottom (10).

8. A container according to any of claims 4,6 or 7 wherein the centre of the container bottom is involuted and the involution comprises an inner section (6), a first annular section (7) having a larger diameter, which is located next to the inner section, and a second annular section (8) of smaller diameter, which is located closer to the bottom, and wherein the bottom part (4) of the gas container is provided with at least one section (3) which wraps around the first annular section (7) of the container bottom from the inside.

9. A container according to any of claims 4,6 or 7 wherein the container bottom is provided with several small involutions (13) or an annular, groove-shaped involution (14), wherein the bottom part (4) of the gas container contains at least one section (3) which snaps around the small involutions (13) or the annular, groove-shaped involution (14).

10. A container according to claim 9 wherein the involutions (13) are shaped like mushrooms or wherein the groove-shaped involution (14) has a mushroom-shaped cross-section.

11. A container according to any of claims 5,6 or 7 wherein the centre of the container bottom is domed and wherein the container bottom is provided with several small projections (15), which however do not extend beyond the height of the involution, or with a corresponding annular, groove-shaped projection (16), and wherein the bottom part of the gas container contains at least one section (4) which snaps into the smaller projections (15) or the annular, groove-shaped projection (16).

12. A container according to any of the preceding claims wherein said parts (4,5) of the gas container are made of plastic.

13. A container according to any of the preceding claims wherein said container parts (4,5) of the gas container are joined together by means of a click connection.

14. A container according to any of claims 1 through 12 wherein said container parts (4,5) of the gas container form an integral part.

15. A gas container (11) for a beverage container according to any of claims 1 through 14.
